(19) United States
(12) Patent Application Publication
(10) Pub. No.: US 2026/0022795 A1
(43) Pub. Date: Jan. 22, 2026

(54) ROTARY STAND STRUCTURE CAPABLE OF PASSIVELY POSITIVELY AND NEGATIVELY ROTATING 360 DEGREES

(71) Applicant: L’s Giant Co., Taipei City (TW)

(72) Inventor: CHUNG-HO LAI, Taipei City (TW)

(21) Appl. No.: 19/339,690

(22) Filed: Sep. 25, 2025

Related U.S. Application Data
(63) Continuation-in-part of application No. 18/229,163, filed on Aug. 1, 2023.

(51) Int. Cl. F16M 11/20

(52) U.S. Cl. CPC F16M 11/2014

(57) ABSTRACT

The present invention relates to a rotary stand structure capable of passively positively and negatively rotating 360 degrees, mainly including a main body, a rotary inner sleeve and a transmission component. The main body includes an outer sleeve tube and a plurality of foot stands outwardly radiated from the periphery of the outer sleeve tube. The rotary inner sleeve and the transmission component are arranged in the outer sleeve tube. The rotary inner sleeve at least includes an inner sleeve tube and at least a bearing sleeved on the outer periphery of the inner sleeve tube and contacted with an inner wall of the outer sleeve tube. In the transmission component, the small gear is driven by a motor to make the big gear rotate, and the rotary inner sleeve is driven to rotate concentrically with the outer sleeve tube via the bearing through the convex platform arranged on a top surface of the big gear to be adapted with a concave groove arranged on the bottom surface of the inner sleeve tube.

### RELATED APPLICATIONS

This application is a continuation-in-part application of U.S. application Ser. No. 18/229,163 filed on Aug. 1, 2023, the disclosure of which is hereby incorporated by reference herein in its entirety.

### BACKGROUND OF THE INVENTION

### 1. Field of the Invention

The present invention relates to a foot stand mechanism, and in particular, to a rotary angle stand structure capable of passively positively and negatively rotating 360 degrees.

### 2. Description of the Prior Art

A support foot stand for supporting an exhibit or an ornament on the market is usually a simple foot stand structure. Therefore, when the exhibit or the ornament needs to use electric power, an extension cord with a socket must be externally connected to perform a power supply action, but there is a risk of electricity leakage, short circuit, etc. occurred in the extension cord in use. Also, the arrangement of the extension cord may result in that the rotation of the exhibit or the ornament is to be limited, that the exhibit or the ornament when rotated to a certain angle will be limited at by the extension cord and has to be rotated reversely, and that a 360-degree rotation mode cannot be achieved by repeating both positive rotation and negative rotation. Therefore, there has been a self-powered support foot stand on the market. However, the support foot stand does not have an appropriate functional structure to be used when the exhibit or the ornament needs to be rotated and displayed.

As described above, there are still problems in the conventional technique now. Therefore, in view of the above-mentioned problems, the present inventor intends to make an improvement and an innovation, and a rotary stand structure capable of passively positively and negatively rotating 360 degrees has been finally successfully developed and completed through years of painstakingly deep consideration.

### SUMMARY OF THE INVENTION

In order to overcome the problems of the prior art, it is the object of the present invention to provide a safe and conveniently-usable rotary stand structure capable of passively positively and negatively rotating 360 degrees.

In order to achieve the afore-mentioned object, the present invention provides a rotary stand structure capable of passively positively and negatively rotating 360 degrees, mainly including a main body, a rotary inner sleeve and a transmission component. An outer sleeve tube is arranged in an axle center of the main body. The rotary inner sleeve is sleeved in the outer sleeve tube. The rotary inner sleeve includes an inner sleeve tube, at least a bear and a rubber sleeve. The bearing and the rubber sleeve are sleeved on an outer wall of the inner sleeve tube and contacted with an inner wall of the outer sleeve tube, to keep the rotary inner sleeve and the outer sleeve tube concentric. The transmission component is arranged below the rotary inner sleeve in the outer sleeve tube. The transmission component at least includes a motor, a small gear, a big gear, a clutch, a wire, and an end socket. The clutch is connected to the motor, with the small gear being engaged with the big gear and the clutch. There is a convex platform adapted with a concave groove arranged on the bottom surface of the inner sleeve tube on the top surface of the big gear. A plurality of collector rings are arranged in the inside of the big gear, with the collector rings are electrically connected to the end socket through the wire.

Wherein, the transmission component further includes a contact point bracket, a plurality of copper contact points that penetrate out of the contact point bracket penetrate into the contact point bracket, at least a spring being arranged on the bottom of the copper contact points, the copper contact points being abutted against through the spring, so that the copper contact points make contact with the collector rings continuously.

Wherein, the inner sleeve tube is arranged with a passage, and a part of the wire of the transmission component is arranged in the passage and extends to the outside of the inner sleeve tube.

Wherein, the transmission component further includes an external power source connection, and the external power source supplies electric power to the transmission component for use.

Wherein, the maim body, the rotary inner sleeve, and the transmission component are made of fire proofing plastic and metal.

### BRIEF DESCRIPTION OF THE DRAWINGS

FIG. 1 is a three-dimensional outside view of the present invention;

FIG. 2 is a three-dimensional view of another embodiment of the present invention;

FIG. 3 is an exploded view of the present invention;

FIG. 4 is a sectional view of the present invention;

FIG. 5 is a three-dimensional exploded view of a rotary inner sleeve and a transmission component according to the present invention from another perspective;

FIG. 6 is a partially exploded schematic view of a rotary inner sleeve and a transmission component according to the present invention;

FIG. 7 is a three-dimensional exploded view of an inner sleeve tube and a big gear according to the present invention from another perspective;

FIG. 8 is a three-dimensional exploded view of a transmission component according to the present invention;

FIG. 9 is a three-dimensional outside view of a small gear and a clutch according to the present invention from another perspective;

FIG. 10 is a three-dimensional outside view of a big gear, a big collector ring, a small collector ring and copper contact points according to the present invention;

FIG. 11 is a side sectional view of a rotary inner sleeve and an outer sleeve tube according to the present invention; and

FIG. 12 is a side sectional view of a transmission component according to the present invention.

### REFERENCE CHARACTER LIST

1: main body
11: outer sleeve tube
12: foot stand
121: positioning portion
122: support leg
123: fixing piece
2: rotary inner sleeve
21: inner sleeve tube
211: passage
212: concave groove
22: bearing
23: rubber sleeve
3: transmission component
31: motor
311: transmission shaft
32: small gear
33: big gear
331: convex platform
332: big collector ring
333: small collector ring
34: wire
35: end socket
36: contact point bracket
361: copper contact point
362: spring
363: contact point wire
37: compression spring
38: external power source

### DETAILED DESCRIPTION OF THE INVENTION

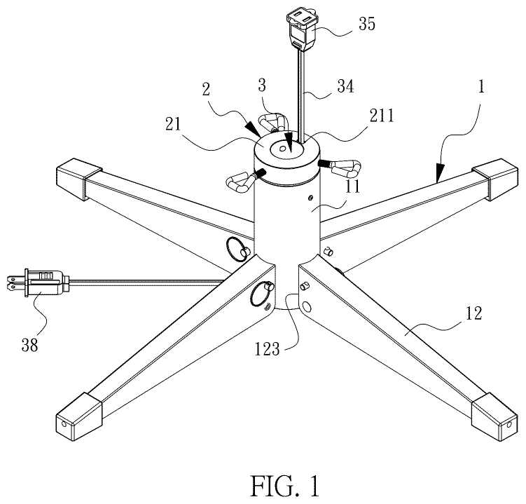

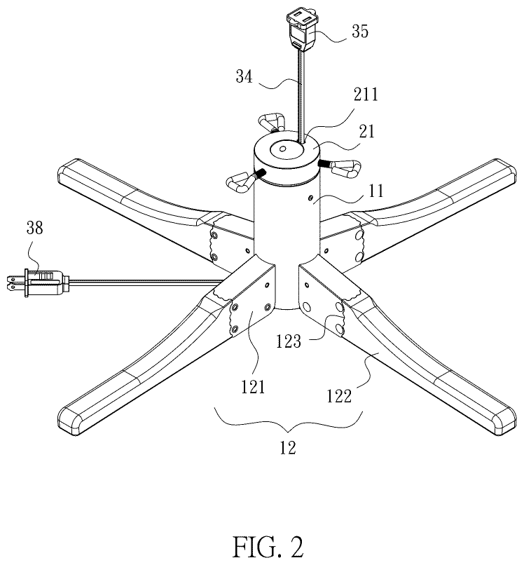

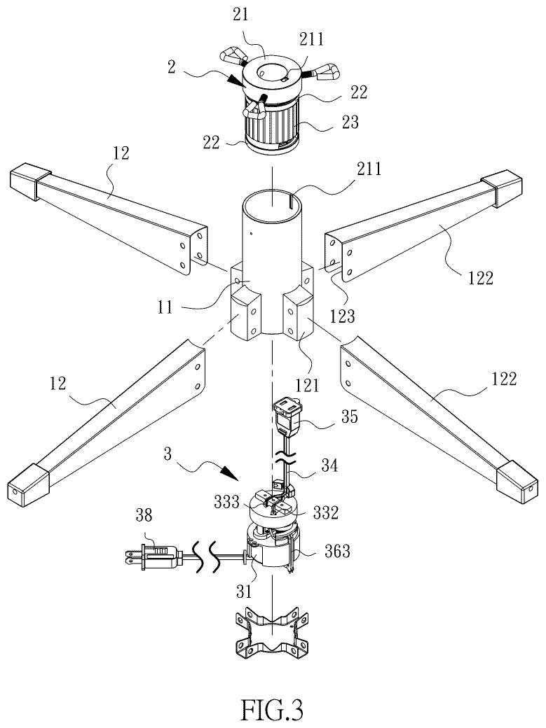

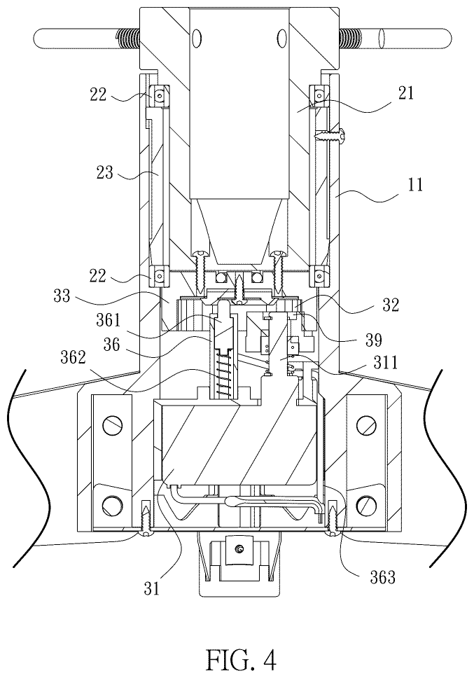

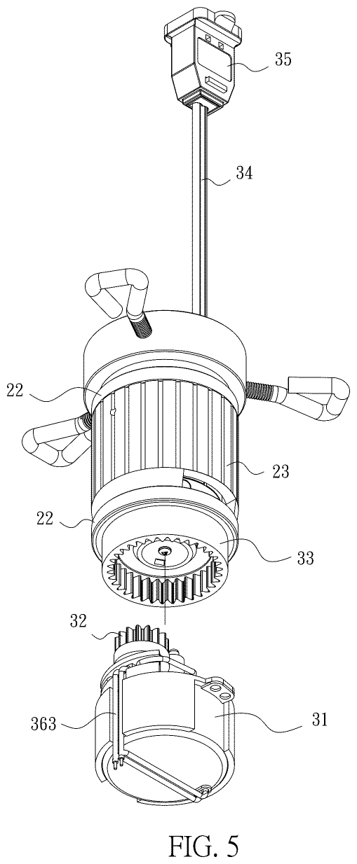

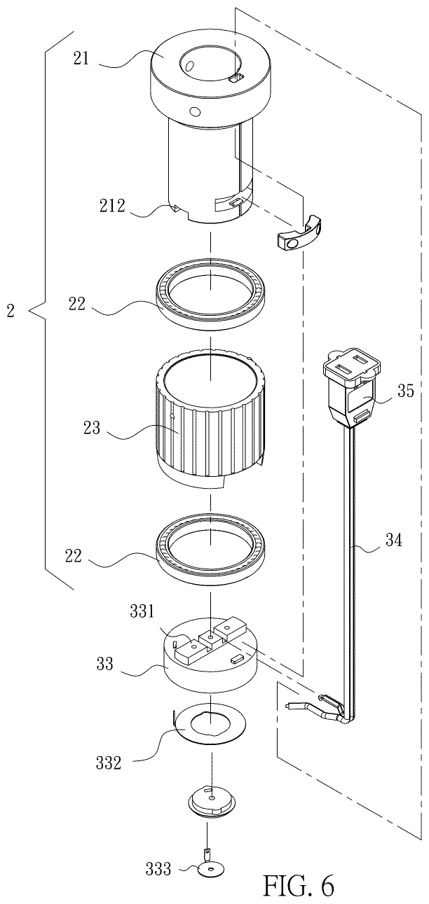

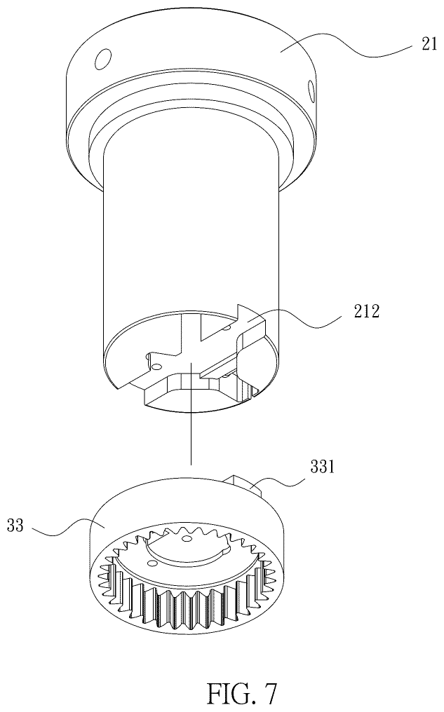

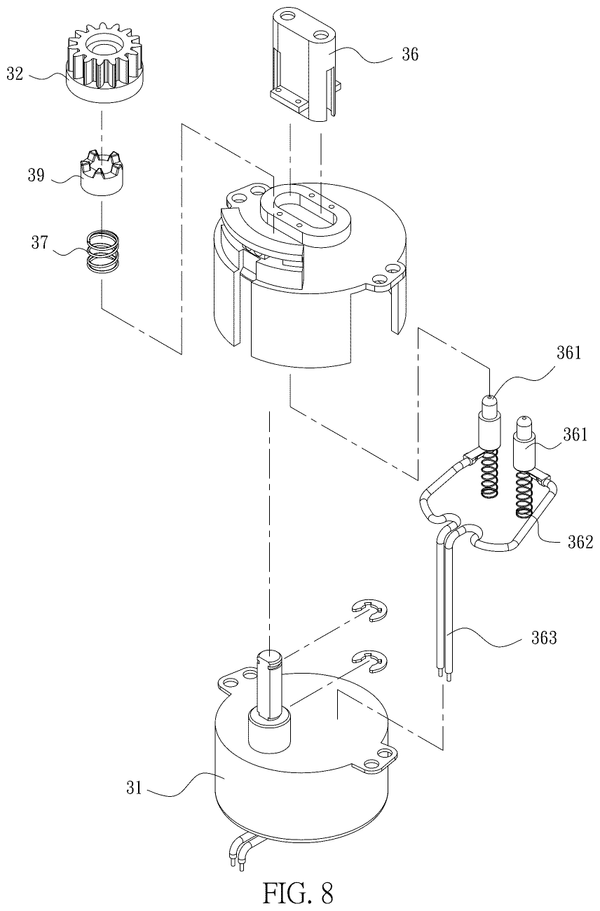

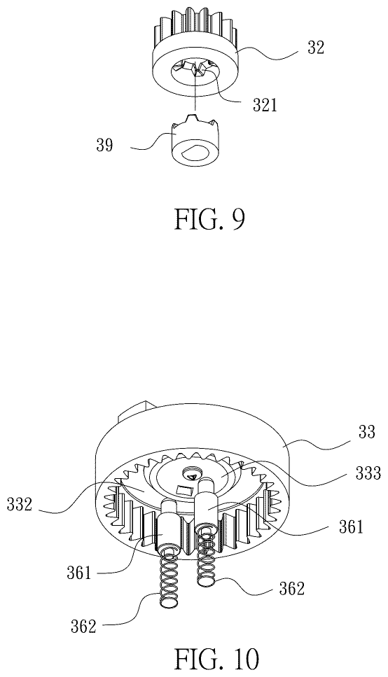

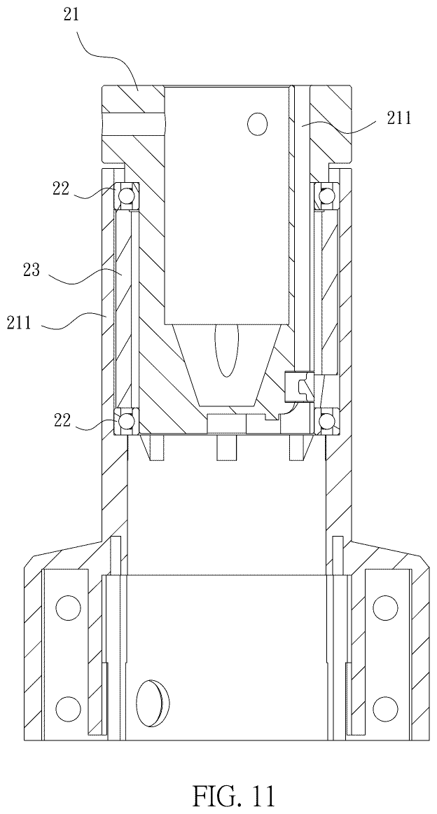

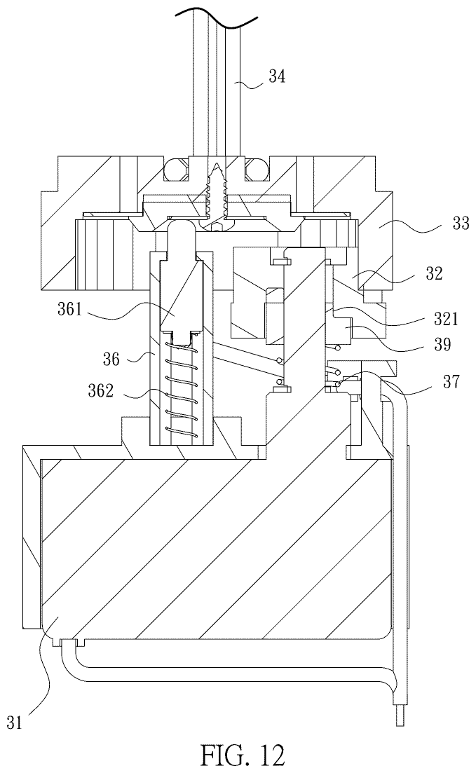

Referring to FIGS. 1 to 12, a first embodiment of the rotary stand structure capable of passively positively and negatively rotating 360 degrees provided by the present invention is shown. In the embodiment, the rotary stand structure capable of passively positively and negatively rotating 360 degrees provided by the present invention at least includes a main body 1, a rotary inner sleeve 2 and a transmission component 3. An outer sleeve tube 11 is arranged in an axle center of the main body 1. A plurality of foot stands 12 used for supporting the main body 1 to achieve stably standing are outwardly radiated from the periphery of the outer sleeve tube 11. Furthermore, the foot stands 12 are consist of a positioning portion 121 connected to the periphery of the outer sleeve tube, and a support leg 122 and a fixing piece 123 corresponding to the positioning portion 121, wherein, in the embodiment, the fixing piece 123 is a flat-mouth fixing piece, and in another embodiment as shown in FIG. 2, the fixing piece 123 is a toothed-mouth fixing piece.

The rotary inner sleeve 2 includes an inner sleeve tube 21, two bearings 22 and a rubber sleeve 23. The inner sleeve tube 21 is arranged with a passage 211 penetrating through the inner sleeve tube. The rubber sleeve 23 and the two bearings 22 are sleeved on an outer wall of the inner sleeve tube 21, with the two bearings 22 being respectively arranged on a top portion and a bottom portion of the rubber sleeve 23. In addition, a concave groove 212 is recessed from a bottom surface of the inner sleeve tube 21.

The transmission component 3 at least includes a motor 31, a small gear 32, a big gear 33, a wire 34, an end socket 35, a contact point bracket 36, a compression spring 37, an external power source 38 and a clutch 39. The inner gear 32 and the big gear 33 are both of an internal gear structure with a recessed bottom surface, and a top surface of the small gear 32 is of an external gear structure. A transmission shaft 311 of the motor 31 is connected to a gear shaft of the clutch 39, and teeth on a top surface of the clutch 39 are engaged with the internal gear structure of the bottom surface of the small gear 32. The teeth on the top surface of the clutch 39 and the internal gear structure of the bottom surface of the small gear 32 are bevel gears. The external gear structure of the top surface of the small gear 32 is engaged with the internal gear structure of the bottom surface of the big gear 33. In addition, the compression spring 37 is sleeved on the transmission shaft 311 of the motor 31, and both ends of the compression spring 37 abut against a bottom portion of the clutch 39 and an upper surface of the motor 31 respectively. Furthermore, a convex platform 331 adapted with a concave groove 212 on the bottom surface of the inner sleeve tube 21 is arranged on a top surface of the big gear 33. Two collector rings are arranged on the bottom surface in the inside of the big gear 33. The collector rings include a big collector ring 332 and a small collector ring 333, with the big collector ring 332 and the small collector ring 333 being electrically connected to the wire 34. The other end of the wire 34, which is relatively connected to the big collector ring 332 and the small collector ring 333, passes through the passage 211 of the inner sleeve tube 21 and is electrically connected to the end socket 35. The contact point bracket 36 is arranged below the big collector ring 332 and the small collector ring 333, with the contact point bracket 36 being a housing. A plurality of copper contact points 361 in contact with the big collector ring 332 and the small collector ring 333 respectively penetrate into the contact point bracket 36. A spring 362 is connected below each of the copper contact points 36, and a contact point wire 363 for electrical connection with the external power source 38 is arranged between the copper contact points 361 and the spring 362.

It is the main point of the rotary stand structure capable of passively positively and negatively rotating 360 degrees provided by the present invention to arrange the transmission component 3 and the rotary inner sleeve 2 into the outer sleeve tube 11. The transmission component 3 is connected to the rotary inner sleeve 2, by adapting a convex platform 331 of the big gear 33 in the transmission component 3 with a concave groove 212 on the bottom surface of the inner sleeve tube 21 of the rotary inner sleeve 2. Then, the motor 31 is powered by the external power source 38, with the small gear 32 being used to drive the large gear 33 to rotate, to make the convex platform 331 and the concave groove 212 do linking-up motion. The outer surface of the bearing 22 of the rotary inner sleeve 2 is in contact with an inner edge wall of the outer sleeve tube 11, and the rubber sleeve 23 and the inner edge wall of the outer sleeve tube 11 have a gap therebetween and are not in contact. Therefore, the rotary inner sleeve 2 can rotate coaxially in the outer sleeve tube 11 through the bearing 22, so that the rotary inner sleeve 2 is driven to make a coaxial-rotation in the inner sleeve tube 11 by means of the bearing 22. Further, the exhibit or the ornament mounted on the inventive rotary stand structure is driven to continuously make a rotary action, and it will be rotated reversely when it is subjected to external obstruction, or when it is subjected to touch, or when it is in contact with an obstacle. The exhibit or the ornament mounted on the inventive rotary stand structure is inverted to a state of continuous positive rotation again when it is subjected to external obstruction again. In addition, according to the present invention, electric power is transmitted to the copper contact points 361 through the contact point wire 363 from the external power source 38. The spring 362 abuts against the copper contact points 361, so that the copper contact points 361 are in contact with the big collector ring 332 and the small collector ring 333, to transmit electric power to the end socket 35 via the wire 34 by using the big collector ring 332 and the small collector ring 333, and it is possible to supply electric power from the end socket 35 to the exhibit or the ornament mounted on the inventive rotary stand structure for use.

The present invention can continuously positively and negatively rotate 360 degrees without a limitation. During positive rotation of the present invention, when it is impossible to perform the positive rotation due to human intervention and obstruction or an obstacle, the clutch 39 cannot rotate, and the teeth of the clutch 39 and the internal gear structure of the bottom surface of the small gear 32 are helical gears. As a result, the teeth of the clutch 39 are misaligned with the internal gear structure of the bottom surface of the small gear 32, and the compression spring 37 below the clutch 39 is compressed, so that the clutch 39 is pressed down to disengage from the internal gear structure of the bottom surface of the small gear 32, to avoid damage to the motor 31. In addition, when an obstruction force is greater than a torque force of the motor 31, the transmission shaft of the motor 31 drives the small gear 32 to be engaged with the big gear 33 to rotate continuously reversely automatically. Conversely, during reverse rotation of the present invention, when it is impossible to perform reverse rotation due to human intervention and obstruction or an obstacle, the reverse rotation is also converted into positive rotation through the aforementioned mechanism and actuation mechanism.

Therefore, in the rotary stand structure capable of passively positively and negatively rotating 360 degrees according to the present invention, through the motor 31, the big gear 33 and the teeth of the clutch 39, namely the internal gear structure of the bottom surface of the small gear 32, when the rotary stand structure according to the present invention continuously rotates in a direction and is subjected to a driven force, the rotary stand structure can reversely rotate. By the structure in which the wire 34 is connected to the end socket 33 through the passage 211, and a power transmission structure between the copper contact points 361 and the big collector ring 332 and the small collector ring 333, the rotary stand structure according to the present invention is prevented from being jammed duo to an impact of the wire 34 when rotating, so as to continuously rotate. In addition, in the present invention, through the arrangement of the bearing 22, the rotary inner sleeve 2 and the outer sleeve tube 11 can rotate concentrically and coaxially, so that the rotary stand structure capable of passively positively and negatively rotating 360 degrees according to the present invention can avoid tipping during rotation. Therefore, compared with a conventional support foot stand, the rotary stand structure capable of passively positively and negatively rotating 360 degrees according to the present invention has obvious progress.

The foregoing content only expresses some embodiments of the present invention, and are not intended to be a limitation to the scope of the present invention. A variety of changes and improvements could be made for by those of ordinary skill in the art without departing from the spirit of the invention, which are intended to be included within the scope of the invention as claimed.

What is claimed is:

1. A rotary stand structure capable of passively positively and negatively rotating 360 degrees, comprising at least:
a main body with an outer sleeve tube being arranged in an axle center thereof;
a rotary inner sleeve sleeved in the outer sleeve tube, the rotary inner sleeve comprising an inner sleeve tube, at least a bear and a rubber sleeve, the bearing and the rubber sleeve being sleeved on an outer wall of the inner sleeve tube, an outer wall of the bearing being contacted with an inner wall of the outer sleeve tube, to keep the rotary inner sleeve and the outer sleeve tube concentric; and
a transmission component arranged below the rotary inner sleeve in the outer sleeve tube and connected to the rotary inner sleeve, to drive the rotary inner sleeve to rotate in the outer sleeve tube through the transmission component;
the transmission comprising at least a motor, a small gear, a big gear and a clutch, the clutch being connected to a transmission shaft of the motor, a compression spring that abuts against a bottom portion of the clutch being arranged on the transmission shaft, the small gear being engaged with the big gear and the clutch, a convex platform being arranged on a top surface of the big gear, and the convex platform being in butt joint with a concave groove provided in a bottom surface of the inner sleeve tube; and
during positive rotation of the rotary stand structure, when it is impossible for the rotary stand structure to positively rotate due to human intervention or obstruction, the clutch being stressed to press the compression spring to move toward the compression spring, so that teeth engaged between the clutch and the small gear are misaligned to be disengaged, to avoid damage to the motor, and when resistance is greater than a torque force of the motor, a transmission shaft of the motor driving the small gear and the big gear to automatically reversely rotate.

2. The rotary stand structure capable of passively positively and negatively rotating 360 degrees of claim 1, wherein two collector rings are arranged on a bottom surface inside the big gear 33, the transmission component further comprises a contact point bracket, a plurality of copper contact points penetrate into the contact point bracket, top portions of the copper contact points penetrate out of the contact point bracket to be in contact with the collector rings respectively, at least a spring is arranged on the bottom portion of the copper contact points, the copper contact points are abutted against through the spring, so that the copper contact points make contact with the collector rings continuously respectively.

3. The rotary stand structure capable of passively positively and negatively rotating 360 degrees of claim 2, wherein a contact point wire is arranged between each of the copper contact points and the spring, and the contact point wires are connected to an external power source to provide electric power.

4. The rotary stand structure capable of passively positively and negatively rotating 360 degrees of claim 3, wherein the collector rings are connected to a wire of the transmission component, to transmit electric power to an end socket through the wire.

5. The rotary stand structure capable of passively positively and negatively rotating 360 degrees of claim 4, wherein the inner sleeve tube is arranged with a passage, and the wire penetrates into the passage and extends to the outside of the inner sleeve tube to be connected to the end socket.

6. The rotary stand structure capable of passively positively and negatively rotating 360 degrees of claim 1, wherein the maim body, the rotary inner sleeve, and the transmission component are made of fire proofing plastic and metal.

7. The rotary stand structure capable of passively positively and negatively rotating 360 degrees of claim 1, wherein bottom surfaces of the small gear and the big gear are both of a concave internal gear structure, while a top surface of the small gear is of an external gear structure engaged with the internal gear structure of the big gear.

8. The rotary stand structure capable of passively positively and negatively rotating 360 degrees of claim 6, wherein teeth on the top surface of the clutch are engaged with the internal gear structure of the bottom surface of the small gear, and both the teeth of the clutch and the internal gear structure of the bottom surface of the small gear are bevel gears.
